(19) United States
(12) Patent Application Publication
(10) Pub. No.: US 2011/0243452 A1
(43) Pub. Date: Oct. 6, 2011

(54) ELECTRONIC APPARATUS, IMAGE PROCESSING METHOD, AND PROGRAM

(75) Inventors: Tatsumi Sakaguchi, Kanagawa (JP); Koji Kashima, Kanagawa (JP); Masashi Eshima, Tokyo (JP); Hiroshi Oryoji, Kanagawa (JP)

(73) Assignee: Sony Corporation, Tokyo (JP)

(21) Appl. No.: 13/053,678

(22) Filed: Mar. 22, 2011

(30) Foreign Application Priority Data
Mar. 31, 2010 (JP) 2010-084557

(51) Int. Cl. G06K 9/46

(52) U.S. Cl. 382/190

(57) ABSTRACT

An electronic apparatus includes a storage, a controller, and an output unit. The storage stores images classified into groups, event feature information items indicating features of objects peculiar to each event, and rule information items indicating rules for selecting a representative image representing an event expressed by the images for each group and are different for each event and for each person related to the event. The controller extracts meta information items from the images for each group based on the event feature information items, analyzes superordinate meta information from the extracted meta information items to derive what event is expressed and to whom the event is related in the images, and selects the representative image that represents the derived event from the images based on the rule information item corresponding to the derived event. The output unit outputs a thumbnail image of the selected representative image for each group.

### BACKGROUND OF THE INVENTION

1. Field of the Invention

The present invention relates to an electronic apparatus capable of determining, from moving image data items or still image data items related to a certain event, an image representing the event, and to an image processing method and a program in the electronic apparatus.

2. Description of the Related Art

From the past, there exists the technique of classifying a moving image constituted of a plurality of scenes or still images into groups and extracting a representative image that represents each of the groups.

For example, Japanese Patent Application Laid-open No. 2010-9608 (hereinafter, referred to as Patent Document 1) discloses that a plurality of images are classified into groups based on an instruction of a user and an image desired by the user is extracted as a representative image of each group from images included in the group.

In addition, Japanese Patent Application Laid-open No. 2003-203090 (hereinafter, referred to as Patent Document 2) discloses an image space displaying method in which similar images are brought together into groups based on a feature amount extracted from the images and images are extracted one by one from the respective groups to be displayed.

### SUMMARY OF THE INVENTION

However, in the technique disclosed in Patent Document 1, a user manually determines a representative image, which takes time and effort of the user.

Further, in the technique disclosed in Patent Document 2, the similarity of images is determined using, as a reference, a distance between feature amounts (signal strength) such as a histogram feature, an edge feature, and a texture feature. However, in the case where such a feature amount constituted of only the signal strength is used, even when images do not have similarity in feature amount itself, the user may want to classify the images into the same group. The technique disclosed in Patent Document 2 hardly supports such a case.

Further, by using subordinate meaning information detected by the technique of face detection/face recognition, laugh detection, or the like, it is possible that meaningful classification processing may be executed as compared to the case where a feature amount constituted of only the signal strength is used. However, for example, as a representative image of scenes of a serious event, an image corresponding to a smile or laugh is not considered to be appropriate. In addition, there may be a case where a smile of a user's complete stranger is detected even in a scene of a delightful event, and it is not appropriate to extract that scene as a representative image.

Further, in the case where a plurality of scenes that can be candidates of a representative image are detected from a certain image group, it is difficult to judge which scene is to be set as a representative image even when subordinate meaning information is used.

In view of the circumstances as described above, it is desirable to provide an electronic apparatus, an image processing method, and a program that are capable of selecting, from a plurality of images related to a certain event, an image that reflects details of the event and is appropriate as a representative image.

According to an embodiment of the present invention, there is provided an electronic apparatus including a storage, a controller, and an output unit. The storage stores a plurality of images classified into a plurality of groups, a plurality of event feature information items that indicate features of objects peculiar to each event, and a plurality of rule information items that indicate rules for selecting a representative image representing an event expressed by the plurality of images for each of the groups and are different for each event and for each person related to the event. The controller extracts a plurality of meta information items from the plurality of images for each of the groups based on the plurality of event feature information items, and analyzes superordinate meta information from the extracted meta information items to derive what event is expressed and to whom the event is related in the plurality of images. Further, the controller selects the representative image that represents the derived event from the plurality of images based on the rule information item corresponding to the derived event. The output unit outputs a thumbnail image of the selected representative image for each of the groups.

With this structure, the electronic apparatus abstracts the plurality of meta information items and derives an event expressed by the plurality of images of each group, and then selects a representative image based on the rule information item corresponding to the event, with the result that an image that reflects details of the event and is appropriate as a representative image can be selected. Further, since the rule information items described above are different for each person related to an event, for example, a representative image to be selected also differs depending on the depth of a relationship between a person related to the event and the user. Therefore, the electronic apparatus can select an optimum representative image for the user of the electronic apparatus. Here, the image includes not only a still image originally captured by a still camera, but also a still image (frame) extracted from a moving image.

The storage may store personal feature information indicating a feature of a person having a predetermined relationship with a user. In this case, the controller may extract the meta information items based on the personal feature information and the plurality of event feature information items.

Accordingly, by recognizing a specific person, the electronic apparatus can derive an event as that related to a specific person and select a representative image accordingly.

The plurality of rule information items may include, for each event, a plurality of meta information items to be included in the representative image and a plurality of score information items each indicating a score corresponding to an importance degree of each of the meta information items. In this case, the controller may add the scores corresponding to the respective meta information items for the plurality of images based on the plurality of score information items, and select an image having a highest score as the representative image.

Accordingly, by setting a score corresponding to an importance degree of each meta information item for each event, the electronic apparatus can reliably select a representative image expressing best each event.

The output unit may output character information indicating what the event expresses and to whom the event is related, together with the thumbnail image.

Accordingly, the electronic apparatus can present a thumbnail image of a representative image and also cause a user to easily grasp “Whose” and “What” event is indicated by an event expressed by the representative image.

The controller may select a predetermined number of representative images having high scores and output thumbnail images of the predetermined number of representative images such that the representative image having a higher score has a larger visible area.

Accordingly, by outputting the representative images in accordance with the scores thereof, the electronic apparatus can cause the user to grasp details of the event more easily than the case where one representative image is output. Here, the phrase “to output thumbnail images such that the representative image having a higher score has a larger visible area” includes, for example, to display a plurality of thumbnail images while overlapping part of the images in the order of scores and to change the size of thumbnail images in the order of scores.

According to another embodiment of the present invention, there is provided an image processing method including storing a plurality of images classified into a plurality of groups, a plurality of event feature information items that indicate features of objects peculiar to each event, and a plurality of rule information items that indicate rules for selecting a representative image representing an event expressed by the plurality of images for each of the groups and are different for each event and for each person related to the event. A plurality of meta information items are extracted from the plurality of images for each of the groups based on the plurality of event feature information items. Superordinate meta information is analyzed from the extracted meta information items to derive what event is expressed and to whom the event is related in the plurality of images. The representative image that represents the derived event is selected from the plurality of images based on the rule information item corresponding to the derived event. A thumbnail image of the selected representative image is output for each of the groups.

According to still another embodiment of the present invention, there is provided a program causing an electronic apparatus to execute a storing step, an extracting step, a deriving step, a selecting step, and an outputting step. In the storing step, a plurality of images classified into a plurality of groups, a plurality of event feature information items that indicate features of objects peculiar to each event, and a plurality of rule information items that indicate rules for selecting a representative image representing an event expressed by the plurality of images for each of the groups and are different for each event and for each person related to the event are stored. In the extracting step, a plurality of meta information items are extracted from the plurality of images for each of the groups based on the plurality of event feature information items. In the deriving step, by analyzing superordinate meta information from the extracted meta information items, what event is expressed and to whom the event is related in the plurality of images is derived. In the selecting step, the representative image that represents the derived event is selected from the plurality of images based on the rule information item corresponding to the derived event. In the outputting step, a thumbnail image of the selected representative image is output for each of the groups.

As described above, according to the embodiments of the present invention, it is possible to select, from a plurality of images related to a certain event, an image that reflects details of the event and is appropriate as a representative image.

These and other objects, features and advantages of the present invention will become more apparent in light of the following detailed description of best mode embodiments thereof, as illustrated in the accompanying drawings.

### BRIEF DESCRIPTION OF DRAWINGS

FIG. 1 is a diagram showing a hardware structure of a PC according to an embodiment of the present invention;

FIG. 2 is a diagram showing a functional block used for selecting a representative image by an image display application of the PC according to the embodiment of the present invention;

FIG. 3 is a diagram showing the details of a representative image selection unit in FIG. 2;

FIG. 4 is a flowchart showing a procedure of representative image selection processing by the PC according to the embodiment of the present invention;

FIG. 5 is a diagram conceptually showing processing in which the PC according to the embodiment of the present invention derives most superordinate meta information from subordinate meta information;

FIG. 6 is a diagram conceptually showing a state of the representative image selection processing from moving image data in the embodiment of the present invention;

FIG. 7 is a diagram showing a display example of a thumbnail of a representative image in the embodiment of the present invention;

FIG. 8 is a diagram showing a display example of thumbnails of representative images in another embodiment of the present invention;

FIG. 9 is a diagram showing a display example of thumbnails of representative images in still another embodiment of the present invention; and

FIG. 10 is a flowchart showing a procedure of representative image selection processing by a PC according to another embodiment of the present invention.

### DESCRIPTION OF PREFERRED EMBODIMENTS

Hereinafter, an embodiment of the present invention will be described with reference to the drawings.

(Hardware Structure of PC)

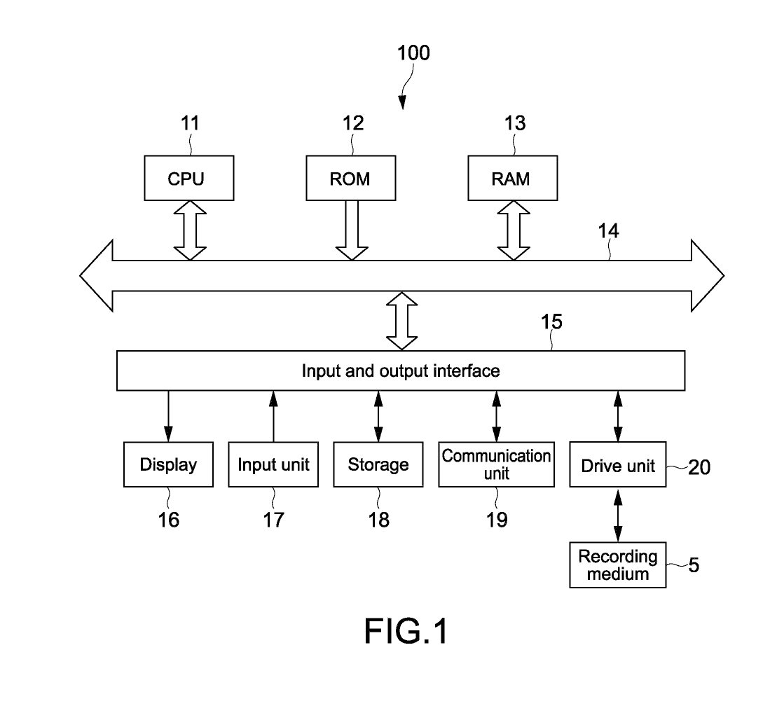

FIG. 1 is a diagram showing a hardware structure of a PC (personal computer) according to an embodiment of the present invention. As shown in FIG. 1, a PC 100 is provided with a CPU (central processing unit) 11, a ROM (read only memory) 12, a RAM (random access memory) 13, an input and output interface 15, and a bus 14 that connects those above components with each other.

The CPU 11 accesses the RAM 13 or the like when necessary and performs overall control of entire blocks of the PC 100 while performing various types of computation processing. The ROM 12 is a nonvolatile memory in which an OS to be executed by the CPU 11, and firmware such as a program and various parameters are fixedly stored. The RAM 13 is used as a work area or the like of the CPU 11 and temporarily stores the OS, various applications in execution, or various data items being processed.

To the input and output interface 15, a display 16, an input unit 17, a storage 18, a communication unit 19, a drive unit 20, and the like are connected.

The display 16 is a display device that uses liquid crystal, EL (electro-luminescence), a CRT (cathode ray tube), or the like. The display 16 may be built in the PC 100 or may be externally connected to the PC 100.

The input unit 17 is, for example, a pointing device such as a mouse, a keyboard, a touch panel, or another operation apparatus. In the case where the input unit 17 includes the touch panel, the touch panel can be integrated with the display 16.

The storage 18 is a nonvolatile memory such as an HDD (hard disk drive), a flash memory, and another solid-state memory. In the storage 18, the OS, various applications, and various data items are stored. In particular, in this embodiment, data of a moving image, a still image, or the like loaded from a recording medium 5, and an image display application for displaying a list of thumbnails of the moving image or still image are also stored in the storage 18.

The image display application can classify a plurality of moving images or still images into a plurality of groups, derive an event expressed by the moving images or still images for each group, and select a representative image representing the event. The storage 18 also stores personal feature information that is necessary for deriving the event and indicates features of a person (parent, spouse, child, brother, friend, etc.) having a predetermined relationship with a user of the PC 100, and event feature information that indicates features of an object peculiar to a certain event.

The drive unit 20 drives the removable recording medium 5 such as a memory card, an optical recording medium, a floppy (registered trademark) disk, and a magnetic recording tape, and reads data recorded on the recording medium 5 and writes data to the recording medium 5. Typically, the recording medium 5 is a memory card inserted into a digital camera, and the PC 100 reads data of a still image or a moving image from the memory card taken out of the digital camera and inserted into the drive unit 20. The digital camera and the PC 100 may be connected through a USB (universal serial bus) cable or the like, to load the still image or the moving image from the memory card to the PC 100 with the memory card being inserted in the digital camera.

The communication unit 19 is a NIC (network interface card) or the like that is connectable to a LAN (local area network), WAN (wide area network), or the like and used for communicating with another apparatus. The communication unit 19 may perform wired or wireless communication.

(Software Structure of PC)

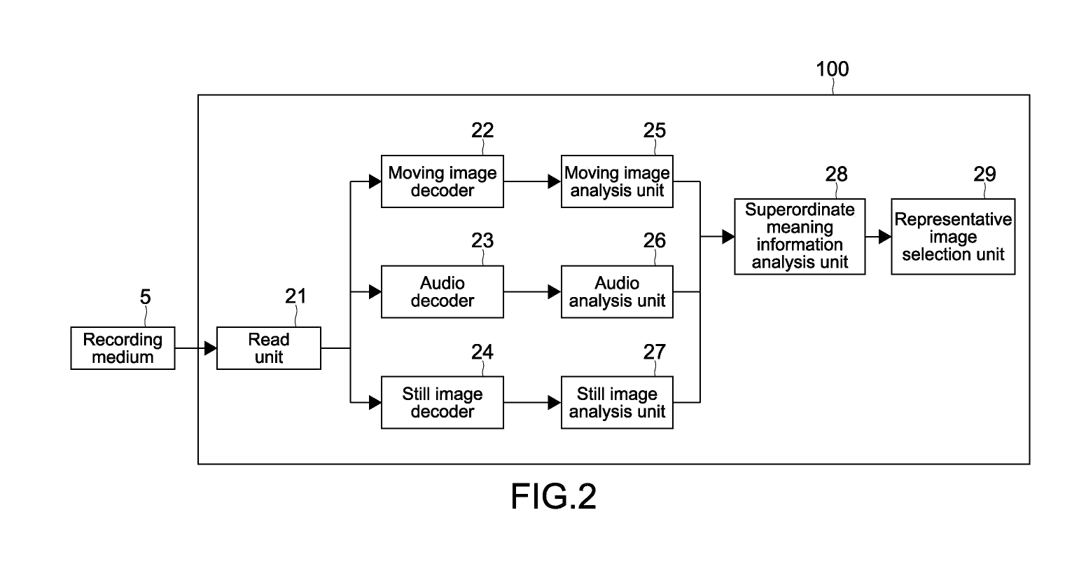

As described above, the PC 100 can classify still images or moving images into a plurality of groups and select and display a representative image (best shot) for each group by the image display application. Here, the group refers to one shot or one scene constituted of a plurality of frames in the case of the moving images, or to a group of images captured at the same date and time or in the same time period, for example, in the case of the still images. FIG. 2 is a diagram showing a functional block used for selecting the representative image by the image display application of the PC 100.

As shown in FIG. 2, the PC 100 includes a read unit 21, a moving image decoder 22, an audio decoder 23, a still image decoder 24, a moving image analysis unit 25, an audio analysis unit 26, a still image analysis unit 27, a superordinate meaning information analysis unit 28, and a representative image selection unit 29.

The read unit 21 reads moving image content or still image data from the recording medium 5. The still image data is read for each group corresponding to a date or a time period, for example. In the case where the data that has read is moving image content, the read unit 21 divides the moving image content into moving image data and audio data. Then, the read unit 21 outputs the moving image data to the moving image decoder 22, outputs the audio data to the audio decoder 23, and outputs the still image data to the still image decoder 24.

The moving image decoder 22 decodes the moving image data and outputs the data to the moving image analysis unit 25. The audio decoder 23 decodes the audio data and outputs the data to the audio analysis unit 26. The still image decoder 24 decodes the still image data and outputs the data to the still image analysis unit 27.

The moving image analysis unit 25 extracts objective feature information from the moving image data and extracts subordinate meta information (meaning information) on the basis of the feature information. In the same way, the audio analysis unit 26 and the still image analysis unit 27 extract objective feature information from the audio data and the still image data, respectively, and extracts subordinate meta information on the basis of the feature information. To extract the subordinate meta information, the personal feature information or event feature information is used. Further, to extract the subordinate meta information, the technique is also used which is described in Understanding Video Events: A Survey of Methods for Automatic Interpretation of Semantic Occurrences in Video, Gal Lavee, Ehud Rivlin, and Michael Rudzsky, IEEE TRANSACTIONS ON SYSTEMS, MAN, AND CYBERNETICS-PART C: APPLICATIONS AND REVIEWS, VOL. 39, NO. 5, September 2009.

In the extraction of the feature information, the moving image analysis unit 25 performs pixel-based processing such as a color and texture feature extraction, a gradient calculation, and an edge extraction, or object-based processing such as detection and recognition of a person or face, recognition of an object, movement detection and speed detection of a person, face, or object.

In the person detection, the moving image analysis unit 25 uses a feature filter indicating a human shape or the like, thereby detecting an area that indicates a person from the moving image. In the face detection, the moving image analysis unit 25 uses, for example, a feature filter that indicates a feature of positional relationships of eyes, a nose, eyebrows, hair, cheeks, and the like or skin color information, thereby detecting an area which indicates a face from the moving image.

In addition, the moving image analysis unit 25 recognizes not only existence or nonexistence of a person or face but also a specific person having a predetermined relationship with the user by using the personal feature information. As the personal feature information, for example, an edge strength image feature, a frequency strength image feature, a higher order autocorrelation feature, a color conversion image feature, or the like is used. For example, in the case where the edge strength image is used, the moving image analysis unit 25 stores, as feature data of a person to be recognized (a person concerned such as a parent, a child, a spouse, and a friend), a grayscale image and the edge strength image, extracts the grayscale image and the edge strength image in the same way from a face image of a person whose face is detected, and performs pattern matching of both the grayscale images and both the edge strength images, thereby recognizing the face of a specific person.

In the object recognition, the moving image analysis unit 25 uses a recognition model stored as the event feature information, thereby judging whether an object to be identified is included or not. The recognition model is constructed from an image for learning in advance by machine learning such as SVM (support vector machines).

Further, the moving image analysis unit 25 is also capable of recognizing the background except the person and object in the moving image. For example, the moving image analysis unit 25 uses the model constructed in advance by the machine learning such as the SVM from the image for the learning, to classify the background of the moving image into scenes such as a town, an interior, an exterior, a seashore, a scene in water, a night scene, a sunset, a snow scene, and congestion.

The audio analysis unit 26 detects, from the audio data, the voice of a person, the sound in an environment except the person, and a feature such as power and pitch thereof in the extraction of the feature information. To distinguish between the voice of a person and the sound in the environment, the duration of audio of predetermined power or more is used, for example.

In the extraction of the feature information, the still image analysis unit 27 performs static processing such as the color and texture feature extraction, the gradient calculation, the edge extraction, the detection of a person, a face, or an object, and the recognition of a background, out of the analysis processing which can be performed by the moving image analysis unit 25.

Further, in the case where tag (label) information such as a text is contained in each data item, the analysis units 25 to 27 extract the tag information as the feature information. As the tag information, for example, information indicating the details of an event or information of a date and time of image taking and a location of image taking is used.

On the basis of the feature information extracted by each of the analysis units 25 to 27, the analysis units 25 to 27 extract subordinate meta information (meaning information) to which more specific meaning is added.

For example, on the basis of the extracted person feature or face feature, the moving image analysis unit 25 recognizes, as the subordinate meta information, the individual, sex, age, facial expression, posture, clothes, number of persons, lineup, or the like. In addition, on the basis of the motion feature, the moving image analysis unit 25 recognizes an active or inactive movement, a rapid or slow movement, or an activity of a person such as standing, sitting, walking, and running or recognizes a gesture or the like expressed with the hand of the person.

The audio analysis unit 26 extracts, as the subordinate meta information, applause, a cheer, a sound from a speaker, a feeling corresponding to voice, a laugh, a cry, the details of a talk, a special extent obtained based on an echo, or the like from the extracted audio feature, for example.

The still image analysis unit 27 recognizes meta information that does not relate to the motion feature, out of the meta information that can be recognized by the moving image analysis unit 25.

For the extraction of the subordinate meta information as described above, for example, a method based on a state space representation such as a Bayesian network, a finite state machine, a conditional random field (CRF), and a hidden Markov model (HMM), a method based on a meaning model such as a logical approach, a discrete event system such as a Petri net, and a constraint satisfaction model, a traditional pattern recognition/classification method such as an SVM, a nearest neighbor method, and a neutral net, or various other methods are used.

The superordinate meaning information analysis unit 28 analyzes superordinate meta information on the basis of the subordinate meta information extracted by each of the analysis units 25 to 27 and derives most superordinate meta information, which can explain the whole of one shot of the moving image or one group of the still images, that is, an event. To derive the event, the technique is also used which is disclosed Event Mining in Multimedia Streams: Research on identifying and analyzing events and activities in media collections had led to new technologies and systems, Lexing Xie, Hari Sundaram, and Murray Campbell, Proceedings of the IEEE|Vol. 96, No. 4, April 2008.

Specifically, on the basis of the subordinate meta information items, the superordinate meaning information analysis unit 28 analyzes a plurality of meta information items corresponding to Who, What, When, Where, Why, and How (hereinafter, referred to as 5W1H), gradually increases the level of abstraction, and eventually categorizes one shot of the moving image or a plurality of still images as one event.

For example, from the moving image or the still image, meta information relating to a person such as “a large number of children”, “a large number of parents and children”, and “gym clothes”, meta information relating to the movement of a person such as an “active movement” and “running form”, and meta information relating to a general object such as a “school building” are extracted. From the sound, meta information such as “voice of a person through a speaker”, “applause”, and a “cheer” is extracted. Further, in the case where positional information such as an “elementary school”, information of the season (date and time) of “fall”, and the like are obtained as other meta information, the superordinate meaning information analysis unit 28 derives an event conceivable by integrating those information items, an “athletic meet in an elementary school”.

Further, regarding the element “Who” out of the elements of 5W1H, for example, the superordinate meaning information analysis unit 28 can express an event by using words indicating a specific individual. In other words, in the case where the subordinate meta information relating to a person taking an image (user), family thereof, or the like is extracted as information indicating “Who”, the superordinate meaning information analysis unit 28 uses the information as it is as the subordinate meta information to judge an event of “athletic meet in an elementary school of Boy A”.

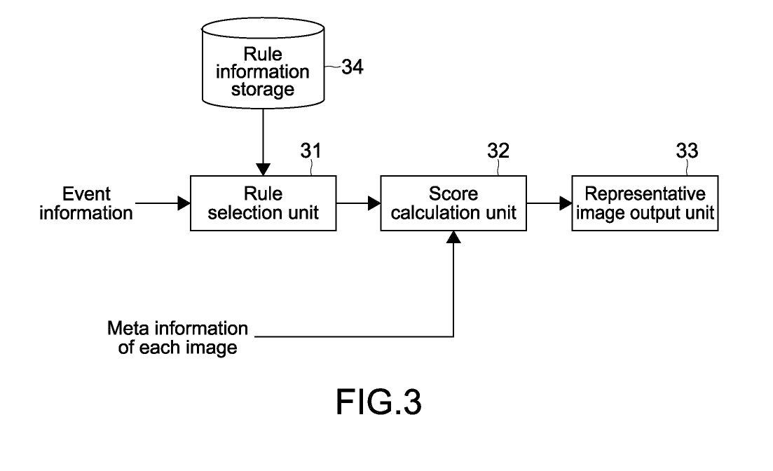

After an event (most superordinate meta information) is derived by the superordinate meaning information analysis unit 28, the representative image selection unit 29 selects an image (frame in the case of moving image) that expresses (represents) the event in the best manner from one shot of the moving image or the plurality of still images. FIG. 3 is a diagram showing the details of the representative image selection unit 29 in FIG. 2.

As shown in FIG. 3, the representative image selection unit 29 includes a rule selection unit 31, a score calculation unit 32, a representative image output unit 33, and a rule information storage 34.

The rule information storage 34 stores rule information as a reference for selecting an optimum representative image for each abstracted event. In other words, the rule information storage 34 retains an importance degree of meta information (subordinate meaning information or objective feature information) used for extracting an event, for each event that the image display application can recognize and for each person related to the event. Here, the importance degree is a priority order to be a reference used when a representative image is selected.

For example, in the case where the event of “athletic meet in an elementary school of Boy A” described above is derived, the following items are included as priority items.

(1) “Boy A appears in images” (face is focused and is not blurred)

(2) “Boy A is having an active posture”

(preferentially during movement)

(3) “Boy A has a smile”

On the other hand, in the case where the derived event merely expresses “athletic meet in an elementary school”, the following priority items are taken.

(1) “as many faces of elementary school students as possible appear in images”

(2) “having an active posture”

(3) “many smiles”

However, in this case, there is no problem even when the matter “a specific person appears in images” is included in rule information similarly to the rule related to the above event of “athletic meet in an elementary school of Boy A” and as a result, an image including “Boy A” is selected as a representative image.

In this manner, by setting rules for selecting a representative image for each event derived by the superordinate meaning information analysis unit 28, it is possible to select a more appropriate representative image reflecting better the details of the event.

Then, the rule information storage 34 stores score information that indicates a score corresponding to the importance degree of each of the priority items included as the rule information.

The rule selection unit 31 reads rule information for each event from the rule information storage 34.

The score calculation unit 32 calculates a score for superordinate/subordinate meta information extracted for each image (still image or frame), according to score information included in the rule information described above. For example, in the above-mentioned example of the athletic meet, a necessary condition is “photograph in which Boy A appears”. The score calculation unit 32 adds scores preset for each meta information item, for example, adds +100 when “a frame in which Boy A appears and which is not defocused and blurred” in the photograph, +50 when Boy A has an “active posture” therein, or +50 when Boy A has a “smile” therein, and calculates the total score of each image.

The representative image output unit 33 selects, as a representative image, an image having a highest score calculated by the score calculation unit 32 out of frames of one shot of the moving image or the plurality of still images in one group, and outputs the image.

(Operations of PC)

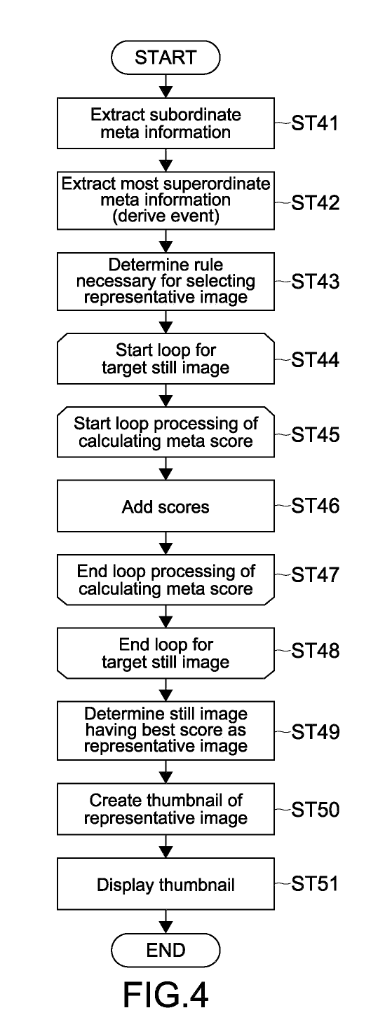

Next, a description will be given on a representative image selection operation by the PC 100 structured as described above. In the following description, the CPU 11 of the PC 100 is an operation subject. However, the following operations are also performed in cooperation with another hardware or software such as the image display application. FIG. 4 is a flowchart showing a procedure of the representative image selection processing by the PC 100.

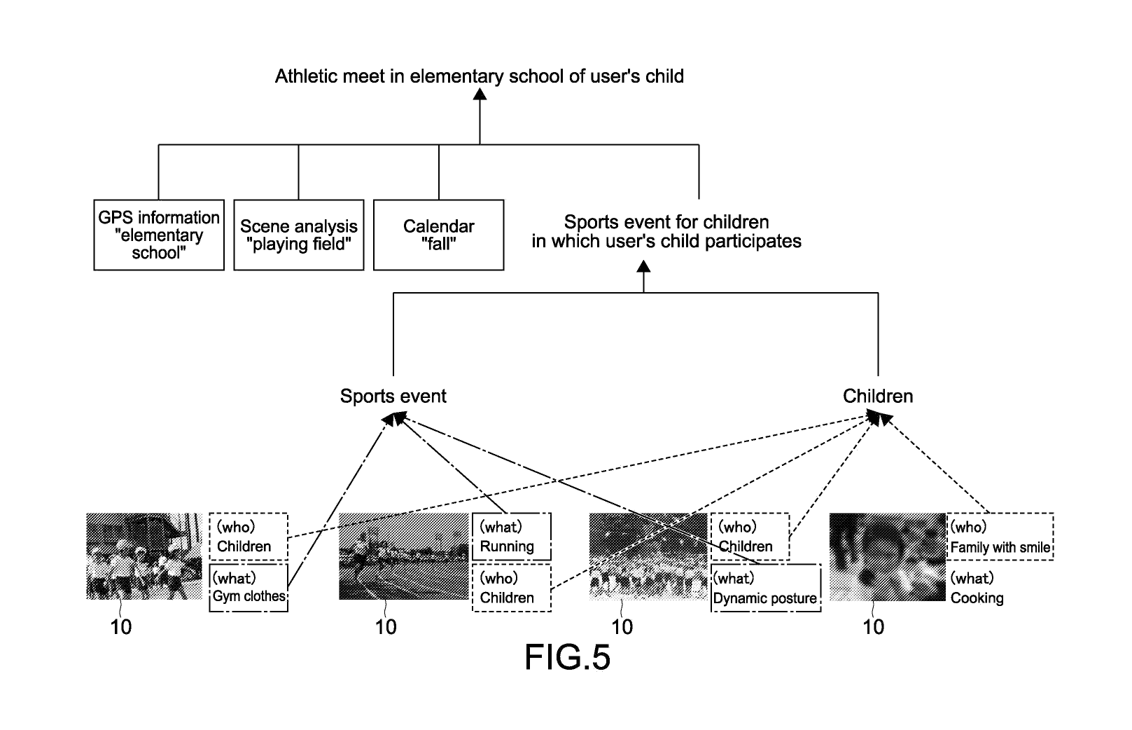

As shown in FIG. 4, the CPU 11 first extracts subordinate meta information by the analysis units 25 to 27 as described above (Step 41), and then derives most superordinate meta information, that is, an event by the superordinate meaning information analysis unit 28 (Step 42). FIG. 5 is a diagram conceptually showing processing of deriving most superordinate meta information from the subordinate meta information.

As shown in FIG. 5, the CPU 11 first extracts subordinate meta information items corresponding to “Who” and “What” from a plurality of photos 10 of a certain group. For example, meta information such as “children (including user's child)” or “family with smile” is extracted as the subordinate meta information corresponding to “Who”, and meta information such as “gym clothes”, “running”, “dynamic posture”, or “cooking” is extracted as the subordinate meta information corresponding to “What”.

Subsequently, the CPU 11 extracts superordinate meta information of “children” from the subordinate meta information corresponding to “Who” described above, and extracts superordinate meta information of “sports event” from the subordinate meta information corresponding to “What” described above.

Then, the CPU 11 extracts more superordinate meta information of “sports event for children in which user's child participates” from the meta information of “children” and the meta information of “sports event”.

Further, as meta information other than the meta information corresponding to “Who” and “What”, the CPU 11 integrates meta information of “elementary school” extracted as GPS information (positional information) from the photos 10, meta information of “playing field” extracted by analysis of background scenes, and meta information of “fall” extracted as calendar information (date-and-time information) with the meta information of “sports event for children in which user's child participates”, thus eventually deriving most superordinate meta information (event) of “athletic meet in an elementary school of user's child”.

Referring back to FIG. 4, subsequently, the CPU 11 determines rule information necessary for selecting a representative image, in accordance with the derived event, by the rule selection unit 31 of the representative image selection unit 29 (Step 43).

Subsequently, the CPU 11 calculates a score of each meta information item for each of the plurality of still images of a certain target group or the plurality of frames constituting one shot of the moving image, based on the rule information described above, and adds those scores (Steps 44 to 48).

Subsequently, the CPU 11 determines a still image or frame having the highest score that has been calculated, as a representative image, out of the plurality of still images or frames of the moving image (Step 49).

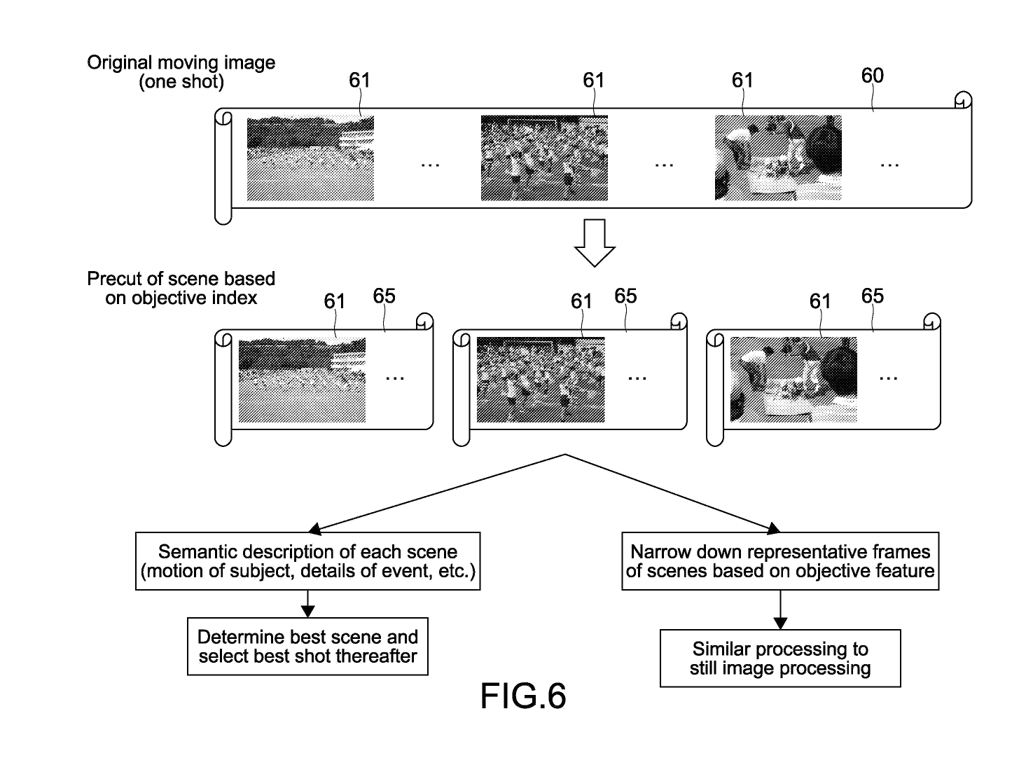

Here, a description will be given on the details of the selection of a representative image from the moving image data. FIG. 6 is a diagram conceptually showing a state of the representative image selection processing from the moving image data.

The representative image selection processing from the moving image data may be performed by totally the same method for still images on the assumption that all frames of the moving image are still images. In reality, however, the efficiency is improved when the processing is performed by a different method.

As shown in FIG. 6, the CPU 11 divides one shot of the original moving image 60 into several scenes 65 based on, for example, objective feature information extracted by processing such as detection of a motion vector (camerawork) or extraction of a subject. Two methods are conceived for the processing performed thereafter.

As shown in the lower left part of FIG. 6, in the first method, in the case where an event expressed by the entire moving image 60 is indicated based on tag information or other meta information, for example, the CPU 11 first selects, for each scene 65, one optimum scene 65 that expresses the event while considering features peculiar to the moving image such as a motion of a subject. After that, the CPU 11 selects a representative frame in the same framework as that for the still image groups described above, out of the frames of the selected scene 65.

As shown in the lower right part of FIG. 6, in the second method, the CPU 11 first narrows down representative frames from the frames of the scenes 65 based on the objective feature. After that, the CPU 11 selects, from the narrowed-down frames, a representative frame in the same framework as that for the still images described above. In this case, also in the processing of narrowing down representative frames in the respective scenes 65, the CPU 11 may select each representative frame by the same processing as that of selecting an eventual representative frame on the assumption that the one scene is one event.

Referring back to FIG. 4, when a representative image is selected, the CPU 11 creates a thumbnail of the representative image (Step 50) and displays the thumbnail on the display 16 (Step 51).

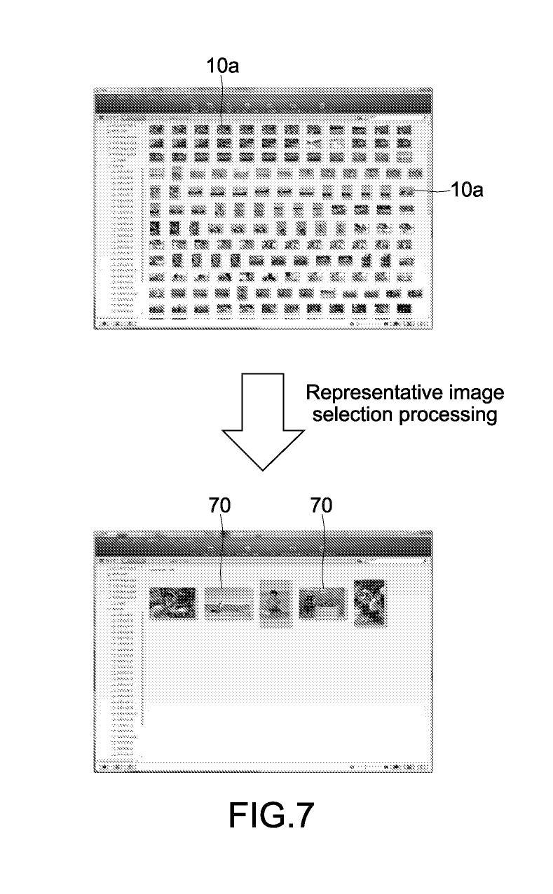

FIG. 7 is a diagram showing a display example of the thumbnail of the representative image. As shown in the upper part of FIG. 7, before a representative image is selected, thumbnails 10a of photos 10 are displayed as a list in a matrix, for example. The thumbnails 10a may be displayed for each group (folder) based on a date or the like. In the upper part of FIG. 7, the thumbnails 10a of photos 10 belonging to a plurality of groups are displayed as a list.

When the representative image selection processing described above is executed from this state at a predetermined timing, as shown in the lower part of FIG. 7, thumbnails 70 of representative images of the groups are displayed instead of the thumbnails 10a of the photos 10. Each of the thumbnails 70 is displayed such that a plurality of rectangles indicating photos 10 in a group are stacked on each other and the thumbnail 70 is positioned on the uppermost rectangle, in order that the user can grasp that the thumbnail 70 expresses a representative image of the photos 10.

### SUMMARY

As described above, according to this embodiment, the PC 100 extracts subordinate meta information items from a plurality of images (still images/moving images) and integrates the subordinate meta information items, with the result that the PC 100 derives superordinate meta information, that is, an event, and then selects a representative image according to rule information set for each event. Therefore, the PC 100 can present a user with an image that reflects the details of the event and is appropriate as a representative image. Accordingly, the user can easily grasp an event from a large number of images and organizes the images. Further, the PC 100 derives “What” and whose (“Who”) event it is, and selects a representative image based on the derived result, with the result that the user can understand the event more easily.

### Modified Example

The present invention is not limited to the above embodiment and can be variously changed without departing from the gist of the present invention.

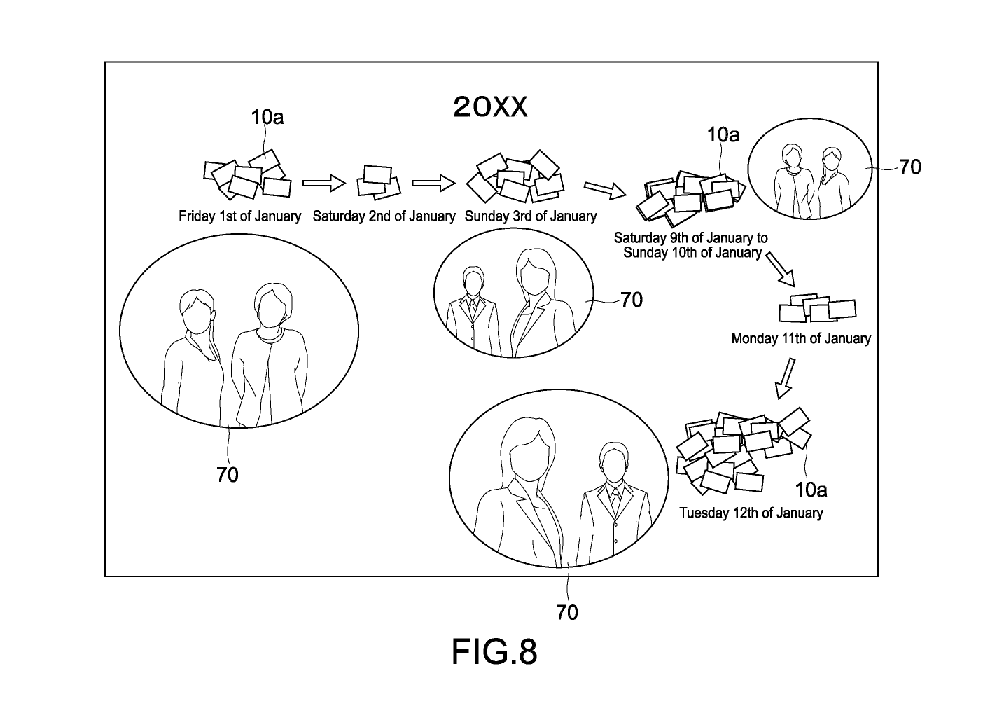

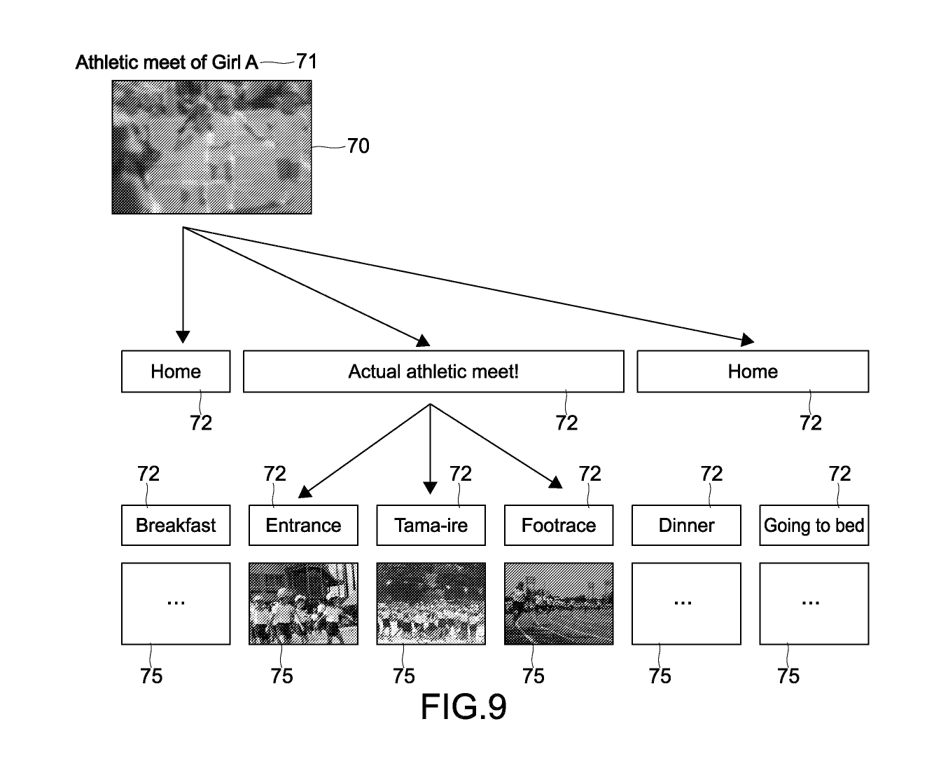

In the above embodiment, the PC 100 displays a thumbnail 70 of each representative image on the uppermost rectangle in the stacked rectangles as shown in FIG. 7, but the display mode of the representative image is not limited thereto. FIGS. 8 and 9 are diagrams showing other display modes of the thumbnail 70 of a representative image.

In the first example, as shown in FIG. 8, the PC 100 may divide the thumbnails 10a of a plurality of photos into groups (clusters) based on a date or the like, display the thumbnails 10a so as to overlap each other at random in each cluster, and display a thumbnail 70 of a representative image of each group in the vicinity of the cluster of each group.

In this case, as the cluster, not thumbnails of all photos belonging to the group but a predetermined number of photos having a higher score of the meta information described above may be selected, and a photo having a higher score may be displayed so as to be positioned to the front. Further, a photo having a higher score may be displayed so as to have a larger visible area. Here, the classification into a plurality of groups may be performed not in unit of date but in unit of similar images, for example. Further, the name of the derived event may be displayed in the vicinity of each cluster, instead of a date displayed in FIG. 8, for example. The name of the event indicates “What” and whose (“Who”) event it is.

In the second example, as shown in FIG. 9, the PC 100 may hierarchically display, for each event, not only a thumbnail 70 of a representative image but also thumbnails 75 of sub-representative images that express a sub-event included in the event. In this case, an event name 71 and sub-event names 72 may also be displayed.

In the example of FIG. 9, regarding an event of “athletic meet of Girl A”, a thumbnail 70 of a representative image and an event name 71 are displayed in the top layer of the hierarchy. In the second layer, sub-event names 72 expressing first sub-events, which correspond to a time course of “home”→“actual athletic meet”→“home”, are displayed. In the third layer, sub-event names 72 expressing second sub-events of “breakfast”, “entrance”, “Tama-ire” (in which balls are thrown into a basket), “footrace”, “dinner”, and “going to bed”, and thumbnails 75 of sub-representative images of the sub-event names 72 are displayed for each of the first sub-events.

To perform such a hierarchical display method, the PC 100 needs to grasp an event in more details than the method shown in FIG. 5 described above. In other words, the PC 100 needs to recognize and categorize subordinate meta information in details to the extent that a sub-event name can be derived. As an example of the method therefor, the PC 100 may derive a sub-event for each subordinate meta information item corresponding to “Who” and “What” and select a representative image for each sub-event in the method shown in FIG. 5, for example. The rule information used in this case is not necessarily prepared for each specific person as in the case of the rule information of the embodiment described above (because a sub-event not related to persons may exist), and therefore specific information of each sub-event only has to be prepared.

In the embodiment described above, the subordinate meta information and the superordinate meta information are extracted by the PC 100, but at least part of those information items may be extracted by another device and input together with the image when an image is input to the PC 100. For example, subordinate meta information items of a photo may be extracted by a digital camera at photo shooting and input to the PC 100 together with the photo, and then the PC 100 may extract superordinate meta information from those subordinate meta information items. Further, subordinate meta information in face detection, night scene detection, or the like, which can be extracted by a digital camera and at a relatively small amount of computation, may be extracted by a digital camera. Meta information in motion detection, generic object recognition, or the like, in which a computation amount necessary for the extraction thereof becomes relatively large, may be extracted by the PC 100. Further, meta information may be extracted by a server on a network in place of the PC 100 and input to the PC 100 via the communication unit 19.

Further, the processing executed by the PC 100 in the above embodiment can also be executed by a television apparatus, a digital still camera, a digital video camera, a mobile phone, a smart phone, a recording and reproduction apparatus, a game machine, a PDA (personal digital assistant), an electronic book terminal, an electronic dictionary, portable AV equipment, and any other electronic apparatuses.

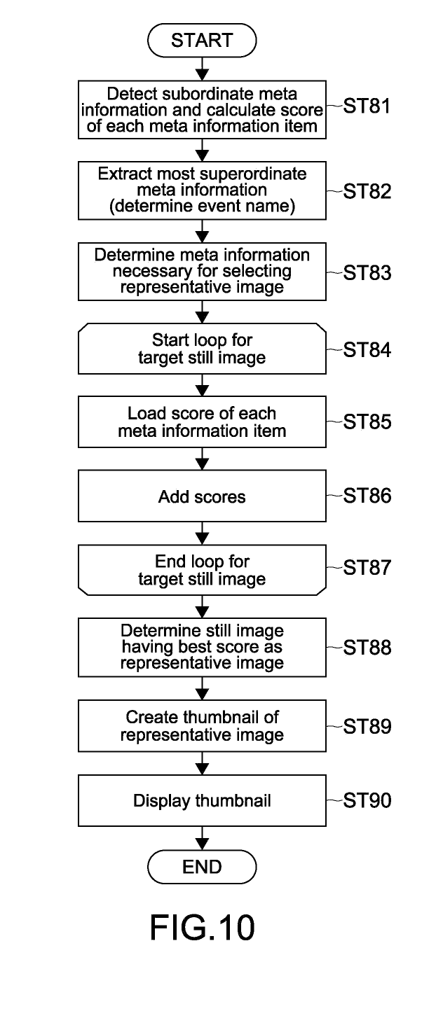

In the above embodiment, as shown in FIG. 4, after an event is derived, the scores of meta information items are calculated accordingly. However, the scores may be calculated at the same time when the processing of extracting subordinate meta information from images is performed. FIG. 10 is a flowchart showing a procedure of representative image selection processing in this case.

As shown in FIG. 10, the CPU 11 extracts subordinate meta information by the analysis units 25 to 27 to calculate a score of each meta information item, and store the score in association with an image (Step 81). Then, after an event is derived, the CPU 11 loads the stored score for each image (Step 85), and adds the stored scores (Step 86), thus selecting a representative image (Step 88).

The subordinate and superordinate meta information extraction processing by the analysis units 25 to 27 and the superordinate meaning information analysis unit 28 in the embodiment described above is not limited to the processing described above. In other words, any processing may be performed as long as subordinate meta information items serving as some objective feature for describing respective images and superordinate meta information derived from the subordinate meta information items are extracted. For example, each meta information item may be an information item added as tag information by a human.

In the rule selection unit 31 of the representative image selection unit 29, it is desirable to rank meta information items in advance for all types of events that can be recognized by an image display application, though not being indispensable. For example, the PC 100 may generate clear rule information in advance particularly only for event groups having a high use frequency (derivation frequency) and replace the rule information with a general rule with respect to other events. The general rule refers to the priority order of subordinate meta information items or an objective feature amount such as a degree of “quality of composition” or “fluctuation/blur”, empirically derived or acquired by learning. Further, in the case where the rule information for event groups having a high use frequency is generated, the user may perform weighting on respective meta information items subjectively, or some kind of machine learning method may be adopted.

In the embodiment described above, the score calculation unit 32 calculates the total score based on the “existence or nonexistence” of the meta information, but the score may be a continuous (stepwise) evaluation value such as a degree of activeness or a degree of a smile, not two values of “existence” and “nonexistence”. Those meta information items may be calculated by the score calculation unit 32, or may be calculated by the analysis units 25 to 27 of FIG. 2. In other words, the processing can be performed in the analysis units 25 to 27, including not only meta information directly related to the derivation of an event, but also information used for selecting a representative image thereafter.

In addition, in combination of the rule selection unit 31 with the score calculation unit 32 in the embodiment descried above, scores of respective events may be calculated by machine learning. By the machine learning determining a score, many meta information items are taken into account as compared to the case where scores are subjectively set for respective events in advance, with the result that an event can be derived more accurately.

In the embodiment described above, a representative image is selected and displayed based on one shot or one scene of a moving image. However, for example, the representative image may be used in moving image edition processing. In other words, although a thumbnail of a frame at an editing point designated by a user is displayed in related art in order to indicate a transition of a scene in one shot, a thumbnail of a representative image may be displayed instead. Further, when a scene search is performed for example, a representative image for each scene may be displayed instead of displaying a frame extracted at a predetermined frame interval as in related art. Accordingly, the accessibility of a user to a scene is improved.

The present application contains subject matter related to that disclosed in Japanese Priority Patent Application JP 2010-084557 filed in the Japan Patent Office on Mar. 31, 2010, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An electronic apparatus, comprising:
a storage configured to store
a plurality of images classified into a plurality of groups,
a plurality of event feature information items that indicate features of objects peculiar to each event, and
a plurality of rule information items that indicate rules for selecting a representative image representing an event expressed by the plurality of images for each of the groups and are different for each event and for each person related to the event;
a controller configured to
extract a plurality of meta information items from the plurality of images for each of the groups based on the plurality of event feature information items,
analyze superordinate meta information from the extracted meta information items to derive what event is expressed and to whom the event is related in the plurality of images, and
select the representative image that represents the derived event from the plurality of images based on the rule information item corresponding to the derived event; and
an output unit configured to output a thumbnail image of the selected representative image for each of the groups.

2. The electronic apparatus according to claim 1, wherein
the storage stores personal feature information indicating a feature of a person having a predetermined relationship with a user, and
the controller extracts the meta information items based on the personal feature information and the plurality of event feature information items.

3. The electronic apparatus according to claim 2, wherein
the plurality of rule information items include, for each event, a plurality of meta information items to be included in the representative image and a plurality of score information items each indicating a score corresponding to an importance degree of each of the meta information items, and
the controller adds the scores corresponding to the respective meta information items for the plurality of images based on the plurality of score information items, and selects an image having a highest score as the representative image.

4. The electronic apparatus according to claim 3, wherein
the output unit outputs character information indicating what the event expresses and to whom the event is related, together with the thumbnail image.

5. The electronic apparatus according to claim 3, wherein
the controller selects a predetermined number of representative images having high scores and outputs thumbnail images of the predetermined number of representative images such that the representative image having a higher score has a larger visible area.

6. An image processing method, comprising:
storing
a plurality of images classified into a plurality of groups,
a plurality of event feature information items that indicate features of objects peculiar to each event, and
a plurality of rule information items that indicate rules for selecting a representative image representing an event expressed by the plurality of images for each of the groups and are different for each event and for each person related to the event;
extracting a plurality of meta information items from the plurality of images for each of the groups based on the plurality of event feature information items;
analyzing superordinate meta information from the extracted meta information items to derive what event is expressed and to whom the event is related in the plurality of images;
selecting the representative image that represents the derived event from the plurality of images based on the rule information item corresponding to the derived event; and
outputting a thumbnail image of the selected representative image for each of the groups.

7. A program causing an electronic apparatus to execute:
storing
a plurality of images classified into a plurality of groups,
a plurality of event feature information items that indicate features of objects peculiar to each event, and
a plurality of rule information items that indicate rules for selecting a representative image representing an event expressed by the plurality of images for each of the groups and are different for each event and for each person related to the event;
extracting a plurality of meta information items from the plurality of images for each of the groups based on the plurality of event feature information items;
analyzing superordinate meta information from the extracted meta information items to derive what event is expressed and to whom the event is related in the plurality of images;
selecting the representative image that represents the derived event from the plurality of images based on the rule information item corresponding to the derived event; and
outputting a thumbnail image of the selected representative image for each of the groups.
